(19) United States
(12) Patent Application Publication
(10) Pub. No.: US 2013/0261844 A1
(43) Pub. Date: Oct. 3, 2013

(54) Traffic Cone and a Traffic Cone System

(71) Applicant: Chien-Ho Ko, Neipu Hsiang (TW)

(72) Inventor: Chien-Ho Ko, Neipu Hsiang (TW)

(21) Appl. No.: 13/430,774

(22) Filed: Mar. 27, 2012

(51) Int. Cl. G05D 1/00

(52) U.S. Cl. 701/2; 701/26

(57) ABSTRACT

A traffic cone includes a body, a transmission device, a driving device, a satellite positioning device, a distance detector, a controller and a power supply device. The transmission device is located under the body for moving the body. The driving device is installed in the body and connected to the transmission device for driving the transmission device. The satellite positioning device is installed in the body and generates a positioning signal. The distance detector is installed in the body and generates a distance signal. The controller is installed in the body and electrically connected to the driving device for controlling the driving device based on the positioning signal and the distance signal. The power supply device is installed in the body for supplying the required power to the traffic cone.

### BACKGROUND OF THE INVENTION

1. Field of the Invention

The present invention generally relates to a traffic cone and, more particularly, to a remotely controllable traffic cone.

2. Description of the Related Art

When a road is under construction, traffic cones are often placed on the road for separation and warning purposes in order to prevent cars or pedestrians from wrongly entering the construction area. Since the traffic cones are conventionally arranged by manpower, it takes considerable time to place the traffic cones on the road one by one when the construction area of the road is in a great length. In addition, it is not easy to orderly place the traffic cones on the road, so that a significant amount of time is consumed in placing the traffic cones. Thus, considerable time and effort is consumed.

Furthermore, when the construction area changes, it requires moving all the traffic cones to a next construction area even though the new construction area is merely a few steps away, leading to an inefficiency in arranging the traffic cones. Moreover, safety issue is raised when workers are on the road moving the traffic cones. Thus, it is desired to improve the convenience in arranging the traffic cones.

### SUMMARY OF THE INVENTION

It is therefore the objective of this invention to provide a traffic cone and a traffic cone system having a plurality of traffic cones, so as to overcome the problem of inconvenient arrangement of the conventional traffic cones.

The invention discloses a traffic cone includes a body, a transmission device, a driving device, a satellite positioning device, a distance detector, a controller and a power supply device. The transmission device is located under the body for moving the body. The driving device is installed in the body and connected to the transmission device for driving the transmission device. The satellite positioning device is installed in the body and generates a positioning signal. The distance detector is installed in the body and generates a distance signal. The controller is installed in the body and electrically connected to the driving device for controlling the driving device based on the positioning signal and the distance signal. The power supply device is installed in the body for supplying the required power to the traffic cone.

In a preferred form shown, the distance detector detects the distance between the body and an external traffic cone, and the distance detector operates with the controller to keep the traffic cone from the external traffic cone at a predetermined distance. Furthermore, the transmission device is a crawler wheel, the distance detector is an ultrasonic distance finder or infrared distance finder, and the power supply device is a solar panel or rechargeable battery.

In another preferred form shown, the invention provides a traffic cone system having a plurality of traffic cones as proposed, as well as a monitoring center. The plurality of traffic cones comprises a first traffic cone and a second traffic cone. The distance detector of the first traffic cone detects a distance between the bodies of the first and second traffic cones. The distance detector and the controller of the first traffic cone operate together to keep the first traffic cone from the second traffic cone at a predetermined distance. The monitoring center is electrically connected to the controllers of the plurality of traffic cones for a user to control the plurality of traffic cones.

In the preferred form shown, each traffic cone further comprises a communication device for communication with the monitoring center. Each traffic cone further comprises a color detector electrically connected to the controller thereof for distinguishing a color and a marking line of an asphalt road, thereby controlling a moving direction of the transmission device thereof.

Therefore, the traffic cone can be efficiently arranged via the provision of the transmission device, the distance detector and the satellite positioning device. In addition, each traffic cone has an independent power supply device; therefore, the traffic cone needn't connect to an external power via a wire. As such, convenient use of the traffic cones is attained.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a diagram of a traffic cone according to a first embodiment of the invention.

FIG. 2 shows a traffic cone system according to a second embodiment of the invention.

FIG. 3 shows an exemplary application of the traffic cone system in FIG. 2.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

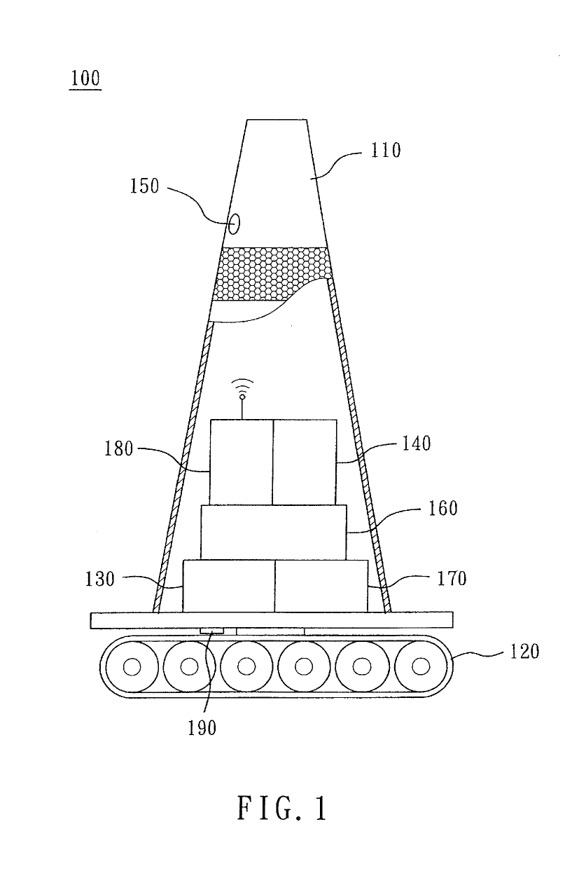

FIG. 1 shows a diagram of a traffic cone according to a first embodiment of the invention. The traffic cone 100 comprises a body 110, a transmission device 120, a driving device 130, a satellite positioning device 140, a distance detector 150, a controller 160 and a power supply device 170. Consumption in time and cost resulting from manual arrangement of the traffic cone as conventionally required can be avoided via arrangement of the transmission device 120 and the distance detector 150. The power supply device 170 can make the traffic cones 100 independent from each other, therefore the traffic cone 100 needn't connect to an external power via a wire. Therefore, convenient use of the traffic cones 100 is attained.

The transmission device 120 is located under the body 110, allowing the body 110 to be moved thereby. In this embodiment, the transmission device 120 is a crawler wheel.

The driving device 130 is in the body 110 and connected to the transmission device 120 for driving the transmission device 120. The most common type of the driving device 130 is a motor, which can be activated to drive the transmission device 120. As such, the body 110 can be moved by the transmission device 120.

The satellite positioning device 140 is in the body 110 and generates a positioning signal. The distance detector 150 is in the body 110 and generates a distance signal. The distance detector 150 in this embodiment is an ultrasonic distance finder, but is not limited thereto. In fact, there are many kinds of instruments for distance measurement, such as an infrared distance finder.

It is worth mentioning that the satellite positioning device 140 merely detects an approximate position of the traffic cone 100. To detect an accurate position of the traffic cone 100, the distance detector 150 fine adjusts the position of the traffic cone 100 based on surrounding environment or objects. As such, accurate self-adjustment or movement of the traffic cone 100 can be provided.

The controller 160 is in the body 110 and electrically connected to the driving device 130, controlling the driving device 130 based on the distance signal. In other words, a user can set distance relations between the body 110 and surrounding objects in advance. Based on the distance relations, the controller 160 uses the distance detector 150 to measure the distances between the body 110 and surrounding objects, thereby controlling the operation timing and period of the driving device 130.

The power supply device 170 is in the body 110 and supplies power to the traffic cone 100. The traffic cone 100 of the invention has an independent power supply device 170 for convenient use. The power supply device 170 can be a solar panel or rechargeable battery, but is not limited thereto.

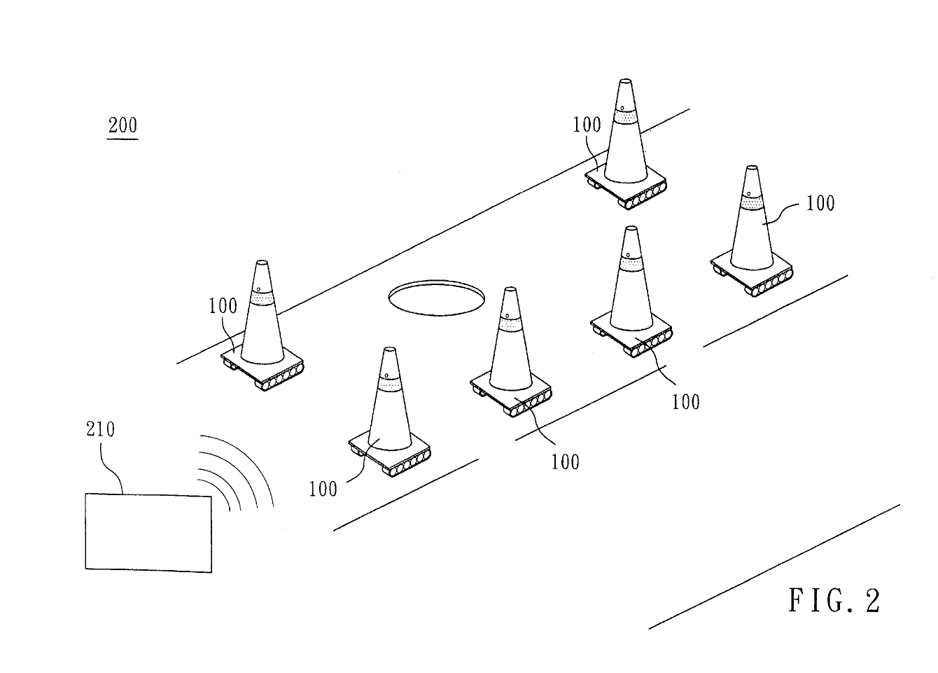

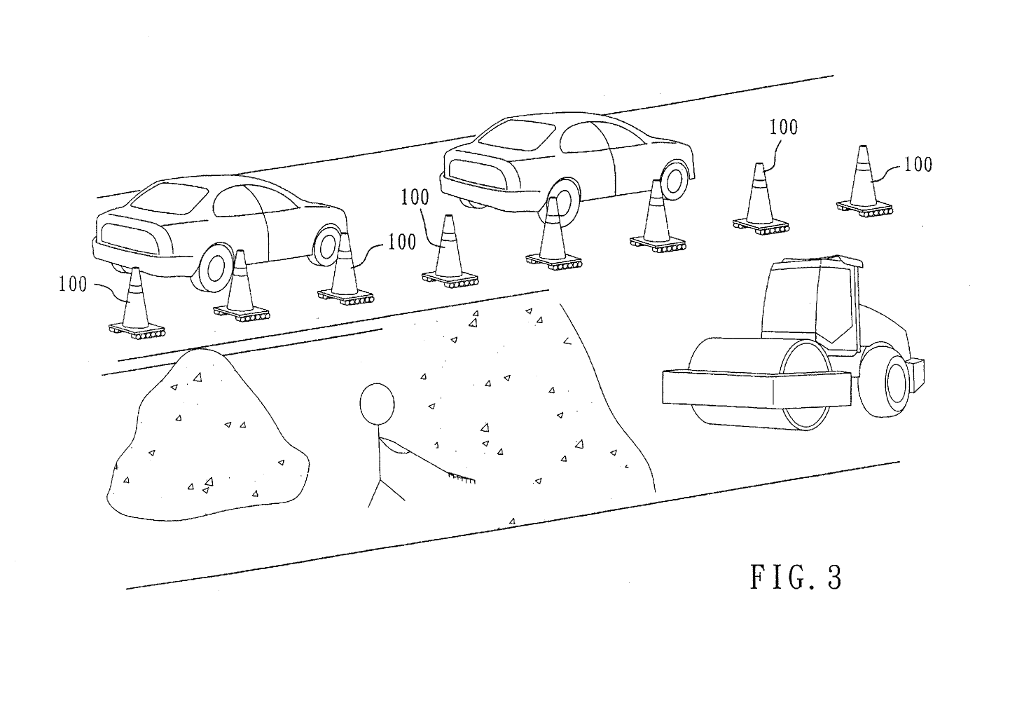

FIG. 2 shows a diagram of a traffic cone system according to a second embodiment of the invention. FIG. 3 shows an exemplary application of the traffic cone system in FIG. 2. Referring to FIGS. 1 to 3, the traffic cone system 200 comprises a plurality of traffic cones 100 and a monitoring center 210. The embodiment focuses on the practical application of the traffic cones 100.

The embodiment has the plurality of traffic cones 100 as described previously. The satellite positioning device 140 of individual traffic cone 100 can determine the position of the traffic cone 100. The distance detector 150 can determine the distance between two bodies 110. The distance can be adjusted according to the ambient environment or the positions of other traffic cones 100. The controller 160 can be used with the satellite positioning device 140 and the distance detector 150 to accurately adjust the distance between two traffic cones 100 and the positions of the traffic cones 100.

The monitoring center 210 is electrically connected to the controller 160 to allow a user to control the traffic cone 100. Specifically, the user can directly control individual traffic cone 100 via the monitoring center 210.

Namely, the user can control the monitoring center 210 to send a signal to the controller 160 of a traffic cone 100, so as to move the traffic cone 100 to a desired location when the construction begins, or move the traffic cone 100 back to where it was when the construction finishes. Besides, the satellite positioning device 140 not only determines the position of the traffic cone 100 but also sends information regarding the instant position of the traffic cone 100 back to the monitoring center 210 for the user.

In this arrangement, the user can recognize whether the traffic cones 100 are placed on right positions or have any breakdown via the monitoring center 210. If it is detected that a traffic cone 100 is broken or placed in an improper position, the user can adjust the position of the traffic cone 100 via the monitoring center 210. Thus, it no longer requires manpower to place and withdraw the traffic cones 100, lowering the costs in construction.

Moreover, the traffic cone 100 may further comprise a communication device 180 and a color detector 190. The communication device 180 is installed in the traffic cone 100 for communication with the monitoring center 210. The communication device 180 allows a worker around the traffic cone 100 to communicate with the user in the monitoring center 210, greatly saving the time and cost.

The color detector 190 is installed in the traffic cone 100 and electrically connected to the controller 160. The color detector 190 is used to distinguish the color and the marking lines of the asphalt road, thereby controlling the moving direction of the transmission device 120. The color detector 190 is arranged to provide accurate movement and placement of the traffic cone 100.

It can be known from the above description that the consumption in time and cost resulting from manual arrangement of the traffic cone can be avoided via arrangement of the transmission device 120 and the distance detector 150, and the power supply device 170 can make the traffic cones 100 independent from each other without requiring the traffic cones 100 to be connected to an external power. Therefore, convenient use of the traffic cones 100 is attained. In addition, the traffic cone system consisting of the plurality of traffic cones 100 and the monitoring center 210 does not cause the consumption in time, manpower and cost resulting from manual placement, alignment and withdrawal of the traffic cones 100. Further, the satellite positioning device 140 can collect and send the information regarding the instant locations of the traffic cones 100 back to the monitoring center 210, greatly increasing the construction safety and quality.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A traffic cone comprising:
a body;
a transmission device located under the body for moving the body;
a driving device installed in the body and connected to the transmission device for driving the transmission device;
a satellite positioning device installed in the body and generating a positioning signal;
a distance detector installed in the body and generating a distance signal;
a controller installed in the body and electrically connected to the driving device for controlling the driving device based on the positioning signal and the distance signal; and
a power supply device installed in the body for supplying the required power to the traffic cone.

2. The traffic cone as claimed in claim 1, wherein the distance detector detects the distance between the body and an external traffic cone, and the distance detector operates with the controller to keep the traffic cone from the external traffic cone at a predetermined distance.

3. The traffic cone as claimed in claim 1, wherein the transmission device is a crawler wheel.

4. The traffic cone as claimed in claim 1, wherein the distance detector is an ultrasonic distance finder.

5. The traffic cone as claimed in claim 1, wherein the distance detector is an infrared distance finder.

6. The traffic cone as claimed in claim 1, wherein the power supply device is a solar panel.

7. The traffic cone as claimed in claim 1, wherein the power supply device is a rechargeable battery.

8. A traffic cone system comprising:
a plurality of traffic cones as claimed in claim 1, wherein the plurality of traffic cones comprises a first traffic cone and a second traffic cone, the distance detector of the first traffic cone detects a distance between the bodies of the first and second traffic cones, and the distance detector and the controller of the first traffic cone operate together to keep the first traffic cone from the second traffic cone at a predetermined distance; and
a monitoring center electrically connected to the controllers of the plurality of traffic cones for controlling the plurality of traffic cones.

9. The traffic cone system as claimed in claim 8, wherein each traffic cone further comprises a communication device for communication with the monitoring center.

10. The traffic cone system as claimed in claim 8, wherein each traffic cone further comprises a color detector electrically connected to the controller thereof for distinguishing a color and a marking line of an asphalt road, thereby controlling a moving direction of the transmission device thereof.
